(19) United States
(12) Patent Application Publication
(10) Pub. No.: US 2018/0062290 A1
(43) Pub. Date: Mar. 1, 2018

(54) SUBSTRATE TERMINAL-EQUIPPED PRINTED CIRCUIT BOARD

(71) Applicant: Sumitomo Wiring Systems, Ltd., Yokkaichi (JP)

(72) Inventor: Hideki Goto, Yokkaichi (JP)

(21) Appl. No.: 15/683,051

(22) Filed: Aug. 22, 2017

(30) Foreign Application Priority Data
Aug. 31, 2016 (JP) 2016-168857

(51) Int. Cl. H01R 12/71; H01R 12/70

(52) U.S. Cl. CPC H01R 12/718; H01R 12/7064

(57) ABSTRACT

Provided is a substrate terminal-equipped printed circuit board having configured to enable a substrate terminal to be fixed to a printed circuit board without using a pedestal, and to reduce the pressure and the insertion force applied to an inner surface of a through hole when the substrate terminal is press-fitted therein. A conducting portion of a substrate terminal includes: a press-fitted portion disposed at a proximal end portion thereof and is press-fitted into a through hole; and a loosely inserted portion that extends from the press-fitted portion to a distal end portion thereof, has a narrower width than the press-fitted portion, and is inserted into the through hole with a gap therebetween, and the press-fitted portion of the conducting portion is in pressure contact only with printed wiring provided on a surface layer of the printed circuit board and with an insulating layer located immediately below the printed wiring.

### CROSS-REFERENCE TO RELATED APPLICATIONS

This claims priority to Japanese Patent Application No. JP 2016-168857 filed Aug. 31, 2016.

### TECHNICAL FIELD

The present invention relates to a substrate terminal-equipped printed circuit board including a substrate terminal that is inserted into a through hole of a printed circuit board and electrically connected to printed wiring of the printed circuit board.

### BACKGROUND

Substrate terminal-equipped printed circuit boards that electrically connect an external electric component and the like to printed wiring of a printed circuit board via a substrate terminal provided upright on the printed circuit board have hitherto been widely used in vehicle electric/electronic systems or the like. The substrate terminal for use in such a substrate terminal-equipped printed circuit board is generally configured such that one end side thereof serves as a connection portion to be connected to an opposing member, and the other end side thereof serves as a conducting portion to be inserted into a through hole of the printed circuit board so as to be electrically connected to the printed wiring.

Meanwhile, in order to hold the substrate terminal in the upright state on the printed circuit board, the substrate terminal is held by a pedestal made of a synthetic resin in a state where the substrate terminal extends through the pedestal, and the substrate terminal is positioned and held by this pedestal on the printed circuit board, as shown in JP 2008-35669A, for example.

However, this conventional structure requires preparation of a separate component, namely, a pedestal, and also requires an operation to press-fit the substrate terminal into the through hole of the pedestal, posing an inherent problem in which an increase in the number of components and costs cannot be avoided. There is also the problem that solder cracking is likely to occur owing to the difference in the coefficient of linear expansion between the pedestal and the printed circuit board.

On the other hand, as described in JP 2003-338333A, it is also proposed that a conducting portion of the substrate terminal is press-fitted into the through hole of the printed circuit board without using a pedestal, thereby establishing connection between the substrate terminal and the printed wiring, and holding the substrate terminal in the upright state on the printed circuit board.

However, in the method involving press-fitting the conducting portion of the substrate terminal into the through hole, there are problems including the detachment of a plated layer of the through hole during press-fitting of the substrate terminal, and printed wiring made of a copper foil or the like provided on an inner layer of the printed circuit board being deformed due to the pressure applied during press-fitting of the terminal. Then, owing to the pressure applied to the printed wiring (inner layer copper foil) or the like of the inner layer during press-fitting, so-called “measling” in which the glass fiber constituting an insulating substrate is detached due to the heat stress generated during a subsequent soldering step or the like. This has resulted in the problem of poor precision of the substrate terminal-equipped printed circuit board as a product. In addition, the necessity of press-fitting into the through hole results in the problem of an increase in the insertion force.

### SUMMARY OF THE INVENTION

The present invention has been made in light of the above-described circumstances, and a problem to be solved by the invention is to provide a substrate terminal-equipped printed circuit board having a novel structure that enables a substrate terminal to be fixed to a printed circuit board without using a pedestal, and can reduce the pressure and the insertion force applied to an inner surface of a through hole when the substrate terminal is press-fitted into the through hole.

A first aspect of the present invention is directed to a substrate terminal-equipped printed circuit board in which a conducting portion of a substrate terminal provided upright on a printed circuit board is inserted into a through hole of the printed circuit board so as to be electrically connected to printed wiring, wherein the conducting portion of the substrate terminal includes: a press-fitted portion that is provided at a proximal end portion thereof and is press-fitted into the through hole; and a loosely inserted portion that is provided so as to extend from the press-fitted portion to a distal end portion thereof, has a narrower width than the press-fitted portion, and is inserted into the through hole with a gap therebetween, and the press-fitted portion of the conducting portion is in pressure contact only with the printed wiring provided on a surface layer of the printed circuit board and with an insulating layer located immediately below the printed wiring.

According to the present aspect, the press-fitted portion that is press-fitted into the through hole is provided on the proximal end portion side of the conducting portion of the substrate terminal. Accordingly, the substrate terminal can be fixed to the printed circuit board utilising the force of press-fitting the press-fitted portion into the through hole, making it possible to eliminate the need for a resin pedestal or the like. Moreover, the proximal end portion of the conducting portion serves as the press-fitted portion that is press-fitted into the through hole, and a portion extending from the press-fitted portion to the distal end portion of the conducting portion serves as the loosely inserted portion that is inserted into the through hole with a gap therebetween. Therefore, the area that is press-fitted when the substrate terminal is press-fitted into the through hole is limited to the press-fitted portion provided on the proximal end portion side that is inserted into the through hole last, thus making it possible to reduce the force involved in inserting the substrate terminal into the through hole and increase the workability.

Furthermore, the press-fitted portion that is press-fitted into the through hole is in pressure contact only with the printed wiring provided on the surface layer of the printed circuit board and with the insulating layer located immediately therebelow, and is brought into pressure contact last in the stage of inserting the conducting portion into the through hole. Accordingly, the distance over which the conducting portion moves downward within the through hole in a state where the conducting portion is in pressure contact with the inner surface of the through hole as in a conventional structure is made as short as possible. This makes it possible to advantageously eliminate or reduce the problem of the plated layer the through hole being detached, and to advantageously reduce failures that adversely affect the insulating layer and the printed wiring inside the printed circuit board that are caused by the pressure applied during press-fitting of the substrate terminal into the through hole, thus making it is possible to advantageously make improvements regarding the issue of the occurrence of failures such as measling in which the force of press-fitting the substrate terminal into the through hole causes deformation of the insulating layer and the printed wiring inside the printed circuit board, and the glass fiber constituting the insulating layer is removed due to heat stress in a subsequent soldering step or the like. Accordingly, it is possible, with a simple structure, to simultaneously ensure the uprightness of the substrate terminal on the printed circuit board through press-fitting the conducting portion into the through hole, and prevent, in advance, problems that may be caused by press-fitting the conducting portion into the through hole.

Note that the conducting portion of the substrate terminal is inserted into the through hole with a gap therebetween over a wide region extending from the press-fitted portion to the distal end portion, so that solder finishing that reaches into the through hole can be favorably achieved as a result of the solder entering into this gap in the subsequent soldering step.

A second aspect of the present invention is directed to the substrate terminal-equipped printed circuit board according to the first aspect, wherein the loosely inserted portion constitutes at least ¾ of a region where the conducting portion of the substrate terminal is disposed in the through hole of the printed circuit board, in a length direction of the through hole.

According to the present aspect, the loosely inserted portion constitutes at least ¾ of the conducting portion disposed in the through hole, in the length direction of the through hole. Accordingly, the region into which the press-fitted portion is press-fitted is limited to only the upper end portion of the through hole, making it possible to more advantageously reduce the insertion force and prevent problems such as measling from occurring.

A third aspect of the present invention is directed to the substrate terminal-equipped printed circuit board according to the first or second aspect, wherein the press-fitted portion of the conducting portion is spaced apart from at least a lower portion of the insulating layer located immediately below the printed wiring provided on the surface layer of the printed circuit board.

According to the present aspect, the press-fitted portion of the conducting portion of the substrate terminal is not in pressure contact with and is spaced apart from the insulating layer located immediately below the printed wiring of the surface layer of the printed circuit board, at least at the lower portion. Therefore, even when the printed wiring is provided below the insulating layer located immediately below the printed wiring of the surface layer, it is possible to advantageously prevent the press-fitting force applied to the insulating layer from further affecting the underlying printed wiring and the boundary thereof, making it possible to more advantageously prevent problems such as measling from occurring.

A fourth aspect of the present invention is directed to the substrate terminal-equipped printed circuit board according to any one of the first to third aspects, wherein a width dimension of an intermediate portion, in a length direction, of the substrate terminal is set to be larger than a width dimension of the conducting portion, and stepped surfaces between the conducting portion and the intermediate portion form a pair of substrate abutment portions on opposite sides of the conducting portion, and a recessed portion that is cut inwardly in a recessed shape in an intersection region between the substrate abutment portion and the press-fitted portion of the conducting portion is formed on an inward side of each of the substrate abutment portions.

According to the present aspect, the stepped surfaces between the conducting portion and the intermediate portion of the substrate terminal form a pair of substrate abutment portions on opposite sides of the conducting portion, thus allowing the substrate terminal to be more advantageously held upright on the printed circuit board, working in conjunction with the press-fitted portion.

In addition, a recessed portion that is cut inwardly in a recessed shape in an intersection region between the substrate abutment portion and the press-fitted portion of the conducting portion is formed on an inward side of each of the substrate abutment portions, so that it is possible to prevent, in advance, a problem in which a rounded remaining portion is formed in the intersection region between the substrate abutment portion and the press-fitted portion during formation of the substrate terminal. Accordingly, it is possible to prevent the occurrence of such a problem where the aforementioned remaining portion interferes with a land portion or the like around the through hole when the substrate terminal is press-fitted into the through hole that results in the substrate terminal being press-fitted in an inclined state.

Furthermore, the recessed portion is formed so as to be open around the press-fitted portion, so that any excess solder can be successfully absorbed, making it possible to advantageously contribute to reliable bonding between the land portion and the substrate terminal via a solder.

A fifth aspect of the present invention is directed to the substrate terminal-equipped printed circuit board according to any one of the first to fourth aspects, wherein the loosely inserted portion of the conducting portion includes: a straight portion that is formed on a proximal end side thereof, extends with a constant width dimension, and is disposed within the through hole; and a tapered portion that is formed on a distal end side thereof, has a width gradually narrowing toward the distal end side, and protrudes outward from the through hole.

According to the present aspect, the loosely inserted portion of the conducting portion includes a straight portion that is formed on the proximal end side, extends with a predetermined width dimension, and is disposed within the through hole. Since the substrate terminal is fixed by being soldered to the through hole at the straight portion that is inserted into the through hole with a constant gap in this manner, the substrate terminal can be soldered with firm and favorable connectability and with improved solder finishing.

The loosely inserted portion of the conducting portion includes a tapered portion that is formed on the distal end side, has a width gradually narrowing toward the distal end side, and protrudes outward from the through hole. This enables the operation of inserting the loosely inserted portion of the conducting portion into the through hole to be performed more easily.

According to the present invention, the press-fitted portion that is press-fitted into the through hole is provided on the proximal end portion side of the conducting portion of the substrate terminal, so that it is possible to fix the substrate terminal to the printed circuit board, and eliminate the need for a resin pedestal or the like. Moreover, the area that is press-fitted when the substrate terminal is press-fitted into the through hole is limited to the press-fitted portion provided on the proximal end portion side that is inserted into the through hole last. Accordingly, it is possible to reduce the force involved in inserting the substrate terminal into the through hole, thus improving the workability. Furthermore, the press-fitted portion that is press-fitted into the through hole is brought into pressure contact last in the stage of inserting the conducting portion in the through hole. Accordingly, the distance over which the conducting portion moves downward within the through hole in a state where the conducting portion is in pressure contact with the inner surface of the through hole as in the conventional structure is made as short as possible. This makes it possible to advantageously reduce failures, which adversely affect the insulating layer and the printed wiring inside the printed circuit board, that may be caused by the pressure applied during press-fitting of the substrate terminal into the through hole, so that it is possible to advantageously make improvements regarding the issue of the occurrence of failures such as measling in which the glass fiber constituting the insulating layer is detached due to heat stress in a subsequent soldering step or the like. Accordingly, it is possible, with a simple structure, to simultaneously ensure the uprightness of the substrate terminal on the printed circuit board, and prevent, in advance, problems that may be caused by press-fitting the conducting portion into the through hole. Here, the conducting portion of the substrate terminal is inserted into the through hole with a gap therebetween, over a wide region extending from the press-fitted portion to the distal end portion, so that solder finishing that reaches into the through hole can be favorably achieved.

### BRIEF DESCRIPTION OF THE DRAWINGS

FIG. 1 is a perspective view showing a substrate terminal constituting a terminal-equipped printed circuit board according to an embodiment of the present invention.

FIG. 2 is a front view of FIG. 1.

FIG. 3 is a perspective view showing the terminal-equipped printed circuit board according to an embodiment of the present invention, showing states ((a) before insertion of the substrate terminal, (b) after insertion of the substrate terminal, and (c) after soldering).

FIG. 4 is a front view of FIG. 3.

FIG. 5 is an enlarged cross-sectional view taken along the line V-V in FIG. 3, showing states ((a) after insertion of the substrate terminal, and (b) after soldering).

### DETAILED DESCRIPTION OF PREFERRED EMBODIMENTS

Hereinafter, an embodiment of the present invention will be described with reference to the drawings.

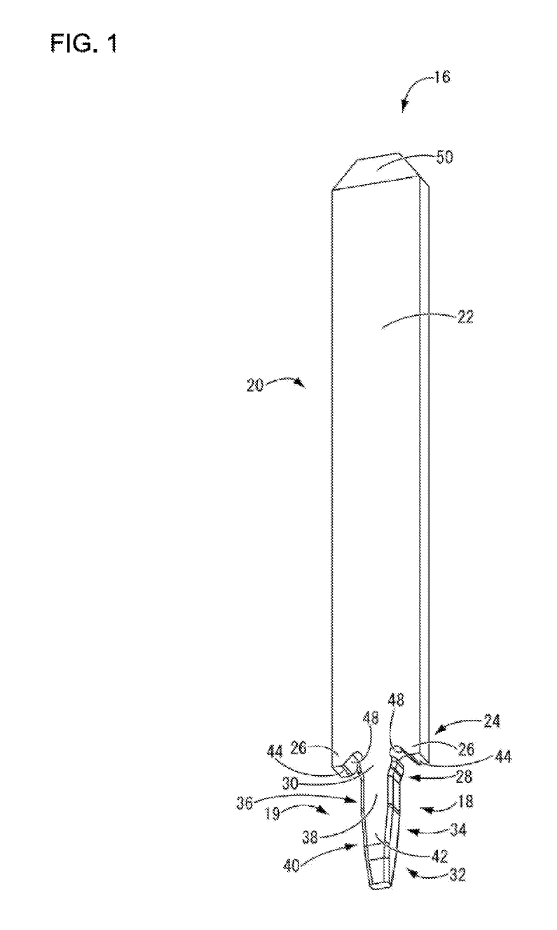

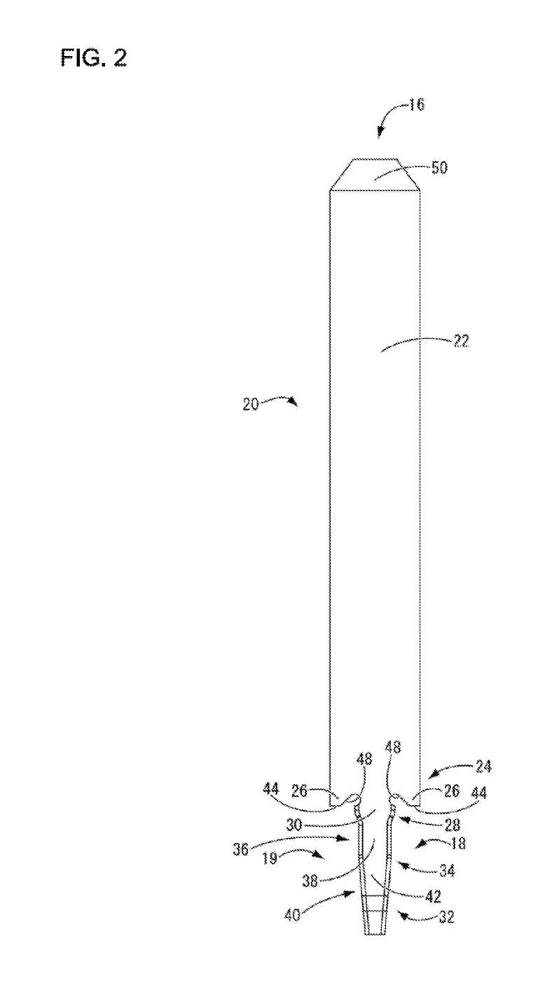

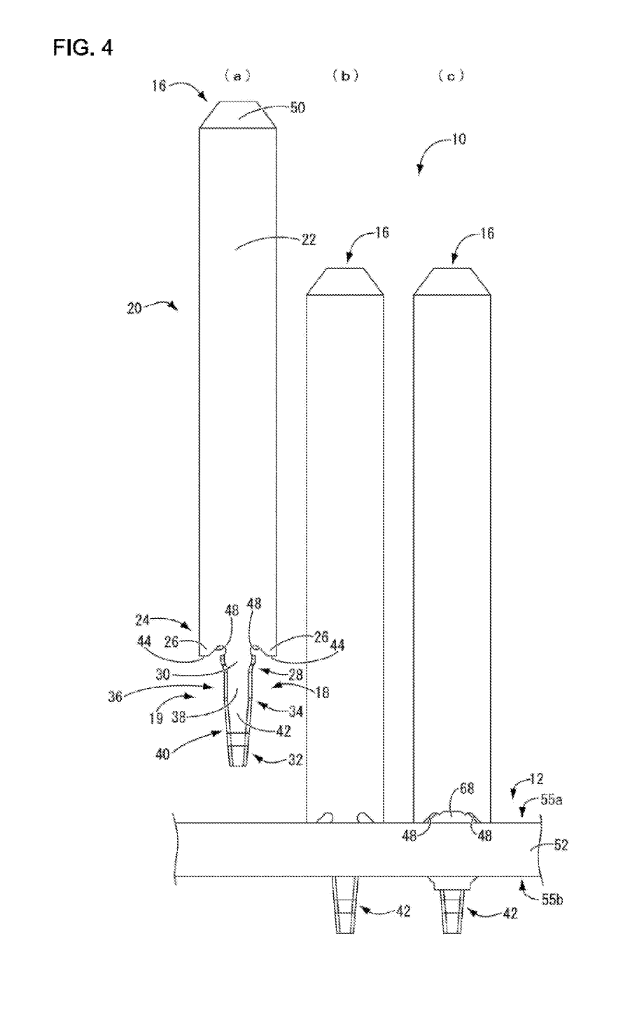

FIGS. 1 to 5 show a substrate terminal-equipped printed circuit board 10 according to an embodiment of the present invention. The substrate terminal-equipped printed circuit board 10 has a structure in which a conducting portion 18 of a substrate terminal 16 is inserted into a through hole 14 of a printed circuit board 12, and the substrate terminal 16 is provided to be upright on the printed circuit board 12. In the following description, a “length direction” and a “vertical direction” refer to the vertical direction in FIGS. 1 to 5, and a “width direction” refers to the lateral direction in FIG. 2. In addition, a “plate thickness direction” refers to a direction perpendicular to the plane of paper in FIG. 2.

As shown in FIGS. 1 to 2, the substrate terminal 16 is formed by press punching a metal plate having a plating of tin or the like formed on the surface of a copper plate, for example, and is formed as an integrally molded article having an overall shape of a substantially strip-shaped flat plate. The conducting portion 18 is provided on one end side 19, in the length direction, of the substrate terminal 16, and a connection portion 22 is provided on the other end side 20. A pair of substrate abutment portions 26 and 26 are provided at an intermediate portion 24, in the length direction, of the substrate terminal 16.

More specifically, a conducting portion 18 having a substantially narrow-width plate shape and protruding downward is provided on one end side 19, in the length direction, of the substrate terminal 16. A press-fitted portion 30 that is press-fitted into the through hole 14 of the printed circuit board 12 is formed at a proximal end portion 28 of the conducting portion 18 by forming opposite side edges, in the width direction (the lateral direction in FIG. 2), of the proximal end portion 28 to protrude outward in a substantially crest-like shape in front view. A loosely inserted portion 34 having a narrower width than the press-fitted portion 30 and having a substantially vertically elongated rectangular shape in front view is formed in a region extending from the press-fitted portion 30 to a distal end portion 32. Furthermore, a straight portion 38 extending with a constant width dimension and having a substantially rectangular shape in front view is formed on a proximal end side 36 of the loosely inserted portion 34, and a tapered portion 42 having a width gradually narrowing toward a distal end side 40, or in other words, downward, and having a substantially inverse trapezoidal shape in front view is formed on the distal end side 40 of the loosely inserted portion 34.

In addition, the width dimension of the intermediate portion 24, in the length direction, of the substrate terminal 16 is set to be larger than the width dimension of the conducting portion 18. As a result, a pair of stepped surfaces 44 and 44 are formed between the conducting portion 18 and the intermediate portion 24, and the pair of stepped surfaces 44 and 44 form a pair of substrate abutment portions 26 and 26 on opposite sides of the conducting portion 18. In addition, a recessed portion 48 that is cut obliquely inwardly in a recessed shape in an intersection region between the substrate abutment portion 26 and the press-fitted portion 30 of the conducting portion 18 is formed on an inward side, in the width direction, of each of the substrate abutment portions 26.

On the other end side 20, in the length direction, of the substrate terminal 16, the connection portion 22 is provided protruding upward in the length direction in a substantially vertically elongated flat plate shape from an upper end portion of the intermediate portion 24. Here, the connection portion 22 has the same width dimension as the intermediate portion 24. That is, the pair of substrate abutment portions 26 and 26 provided at the intermediate portion 24 are formed so as not to bulge outward of the opposite side edges, in the width direction, of the connection portion 22. In addition, a tapered narrow end portion 50 is formed at a distal end edge portion of the connection portion 22, as with a conventionally used terminal.

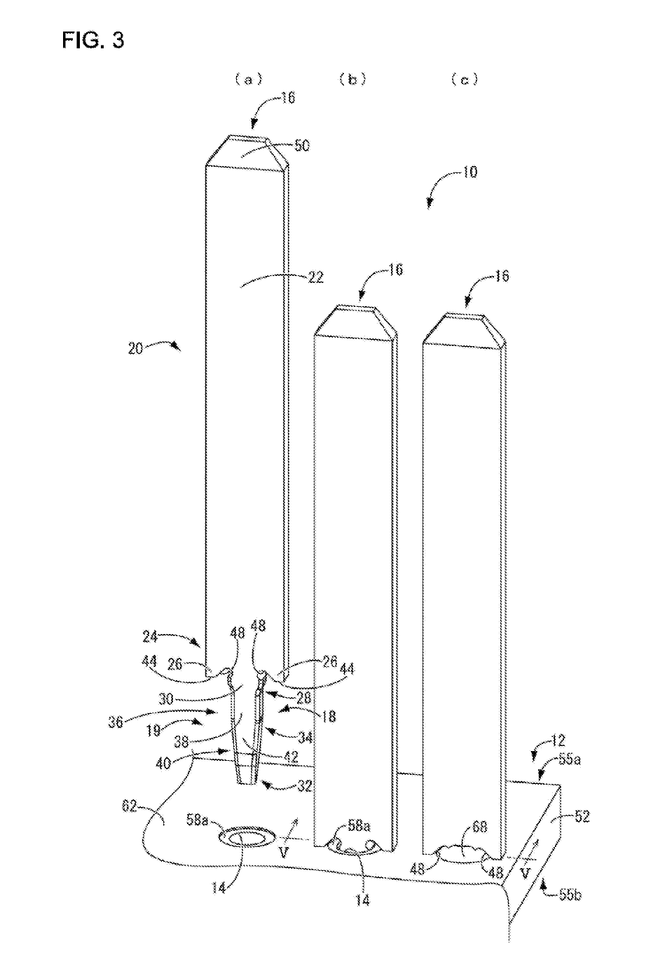

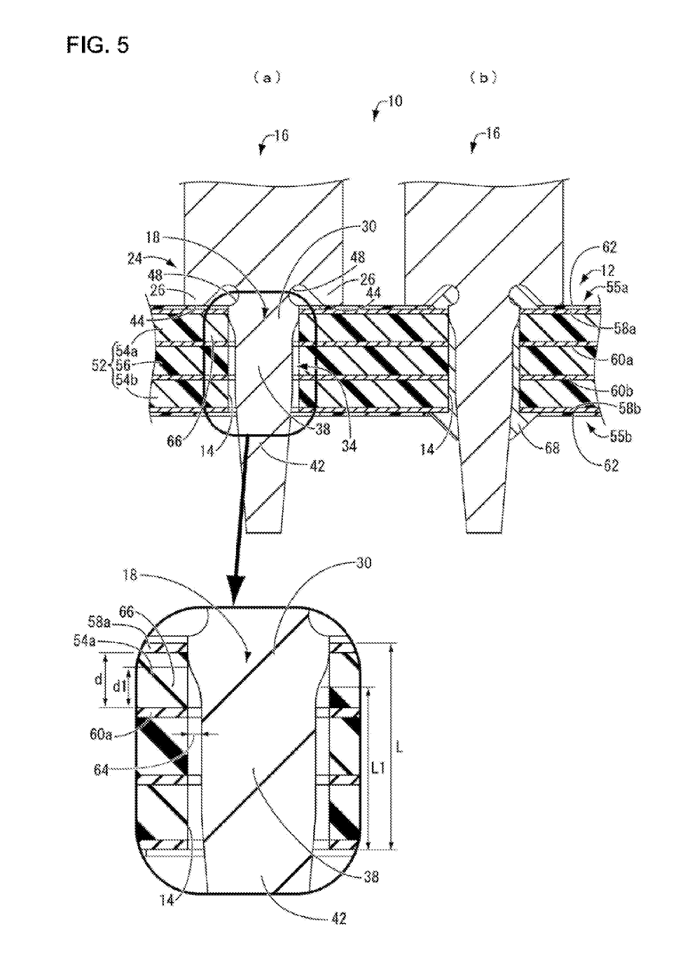

Meanwhile, as shown in FIG. 5, the printed circuit board 12 includes a substantially rectangular flat plate-shaped insulating substrate 52 made of a known insulating material such as a glass epoxy resin. The insulating substrate 52 has a stacked structure in which an inner layer-side insulating layer 56 is interposed between an upper layer-side insulating layer 54a and a lower layer-side insulating layer 54b. An outer layer conductor pattern 58a, which is printed wiring, is formed on a surface layer 55a, which is the top surface of the upper layer-side insulating layer 54a, and an outer layer conductor pattern 58b is formed on a back layer 55b, which is the bottom surface of the lower layer-side insulating layer 54b. Inner layer conductor patterns 60a and 60b, which are printed wiring, are also formed on the top surface and the bottom surface of the inner layer-side insulating layer 56. The surfaces of the outer layer conductor patterns 58a and 58b are mostly covered with a protective resist 62 made of a synthetic resin for the purpose of oxidation prevention or the like, and the protective resist 62 on the outer layer conductor patterns 58a and 58b is removed in a peripheral area of the through hole 14 such that the outer layer conductor patterns 58a and 58b are connected over a wide area, or in other words, at a low resistance, to the conducting portion 18 of the substrate terminal 16 during flow soldering. In addition, as shown in FIG. 3, the through hole 14 of the printed circuit board 12 is constituted by a through hole having a substantially circular cross-sectional shape, and a plated layer (not shown) is attached to the entire inner side of the through hole 14.

As shown in FIGS. 3 to 5, the conducting portion 18 of the substrate terminal 16 configured in this manner is inserted into the through hole 14 of the printed circuit board 12, and provided to be upright. The amount of the substrate terminal 16 inserted into the through hole 14 is defined by the pair of substrate abutment portions 26 and 26 abutting against the printed circuit board 12. In such a state, as shown in (a) of FIG. 5, the press-fitted portion 30 formed at the proximal end portion 28 of the conducting portion 18 is press-fitted into the through hole 14 of the printed circuit board 12, and the straight portion 38 of the loosely inserted portion 34 having a narrower width than the press-fitted portion 30 and extending downward with a constant width dimension is disposed inside the through hole 14, and is inserted into the through hole 14 with a gap 64 therebetween. In such a state, the tapered portion 42 of the loosely inserted portion 34 protrudes outward from the lower opening of the through hole 14.

More specifically, as shown in FIG. 5, the press-fitted portion 30 of the conducting portion 18 is in pressure contact only with the outer layer conductor pattern 58a, which is printed wiring, provided on the surface layer 55a of the printed circuit board 12 and with the upper layer-side insulating layer 54a, which is an insulating layer located immediately below the outer layer conductor pattern 58a. In such a state, the press-fitted portion 30 of the conducting portion 18 is formed so as to be spaced apart from a lower portion 66 of the upper layer-side insulating layer 54a located immediately below the printed wiring 58a provided on the surface layer 55a of the printed circuit board 12. The conducting portion 18 of the substrate terminal 16 is configured such that the ratio (L1/L) of the dimension: L1, in the length direction of the through hole 14, of the loosely inserted portion 34 to the dimension: L, in the length direction, of the through hole 14 in a region disposed within the through hole 14 of the printed circuit board 12 is preferably at least ¾ (75%), and is approximately 80% in the present embodiment. On the other hand, the ratio (d1/d) of the thickness dimension: d1 of the lower portion 66 of the upper layer-side insulating layer 54a located immediately below the printed wiring 58a to the overall thickness dimension: d of the upper layer-side insulating layer 54a is preferably at least ⅕, more preferably at least ½, further preferably at least ⅔, and is approximately 70% in the present embodiment.

Then, as shown in (b) of FIG. 5, a solder 68 is filled into the gap 64, thus electrically connecting the plated layer (not shown) and the outer layer conductor patterns 58a and 58b, which are printed wirings, and the inner layer conductor patterns 60a and 60b to the substrate terminal 16.

With the substrate terminal-equipped printed circuit board 10 having such a structure, the press-fitted portion 30 that is press-fitted into the through hole 14 of the printed circuit board 12 is formed on the proximal end portion 28 side of the conducting portion 18 of the substrate terminal 16, so that the substrate terminal 16 can be fixed in an upright state to the printed circuit board 12 by using the force of press-fitting the press-fitted portion 30 into the through hole 14, making it possible to eliminate the need for a resin pedestal or the like. In addition, the region of the conducting portion 18 of the substrate terminal 16 from the press-fitted portion 30 to the distal end portion 32 is configured as the loosely inserted portion 34 that is inserted into the through hole 14 with a gap 64 therebetween, so that the area that is press-fitted into the through hole 14 is limited to the press-fitted portion 30 provided on the proximal end portion 28 side that is inserted into the through hole 14 last. Therefore, it is possible to reduce the force involved in inserting the substrate terminal 16 into the through hole 14, thus improving the workability.

Furthermore, the press-fitted portion 30 of the conducting portion 18 is in pressure contact only with the outer layer conductor pattern 58a, which is printed wiring, provided on the surface layer 55a of the printed circuit board 12 and with the upper layer-side insulating layer 54a, which is an insulating layer located immediately below the outer layer conductor pattern 58a, so that the distance over which the conducting portion moves downward within the through hole 14 in a state where the conducting portion is in pressure contact with the inner surface of the through hole 14 as in a conventional structure is made as short as possible. This makes it possible to advantageously eliminate or reduce the problems of detachment of the plated layer within the through hole 14, and to advantageously reduce failures, which adversely affect the insulating layers 54a, 54b, and 56 and the printed wirings 58a, 58b, 60a, and 60b within the printed circuit board 12, caused by the pressure applied while press-fitting the substrate terminal 16 into the through hole 14. Therefore, it is possible to advantageously make improvements regarding the issue of the occurrence of failures such as measling in which the aforementioned pressure causes deformation of the insulating layers 54a, 54b, and 56 and the printed wirings 58a, 58b, 60a, and 60b inside the printed circuit board 12, and the glass fiber constituting the insulating layers 54a, 54b, and 56 is detached due to heat stress in a subsequent soldering step or the like. As a result of the foregoing, according to the present embodiment, it is possible, with a simple structure, to simultaneously ensure the uprightness of the substrate terminal 16 on the printed circuit board 12 by press-fitting the conducting portion 18 into the through hole 14, and prevent, in advance, problems that may be caused by such press-fitting force.

The conducting portion 18 of the substrate terminal 16 is configured such that the ratio (L1/L) of the dimension: L1, in the length direction of the through hole 14, of the loosely inserted portion 34 to the dimension: L, in the length direction, of the through hole 14 in a region disposed within the through hole 14 of the printed circuit board 12 is preferably at least ¾ (75%), and is approximately 80% in the present embodiment. This can limit the region into which the press-fitted portion 30 is press-fitted only to the upper end portion of the through hole 14, thus making it possible to more advantageously reduce the force involved in inserting the through hole 14 into the substrate terminal 16 and prevent problems such as measling from occurring. Moreover, the press-fitted portion 30 of the conducting portion 18 is formed so as to be spaced apart from the lower portion 66 of the upper layer-side insulating layer 54a located immediately below the printed wiring 58a provided on the surface layer 55a of the printed circuit board 12. Accordingly, even when the inner layer conductor pattern 60a, which is printed wiring, is provided on the lower portion 66 side of the upper layer-side insulating layer 54a, it is possible to advantageously prevent the inner layer conductor pattern 60a located therebelow and the surroundings from being affected by the pressure applied when the substrate terminal 16 is press-fitted into the through hole 14, thus making it possible to more advantageously prevent problems such as measling from occurring.

In addition, the region of the conducting portion 18 of the substrate terminal 16 from the press-fitted portion 30 to the distal end portion 32 is configured as the loosely inserted portion 34 that is inserted into the through hole 14 with the gap 64 therebetween, and the straight portion 38 that extends with a constant width dimension, is disposed within the through hole 14, and is inserted into the through hole 14 with a constant gap 64 is provided on the proximal end side 36 of the loosely inserted portion 34. Accordingly, solder finishing reaching into the through hole 14 can be favorably achieved by the solder 68 entering into the gap 64 in a subsequent soldering step. Moreover, the tapered portion 42 that has a width gradually narrowing toward the distal end side 40 and protrudes outwardly from the lower opening of the through hole 14 is provided on the distal end side 40 of the loosely inserted portion 34 of the conducting portion 18. Accordingly, it is possible to more easily perform the operation of inserting the conducting portion 18 of the substrate terminal 16 into the through hole 14.

A pair of stepped surfaces 44 and 44 are formed between the conducting portion 18 and the intermediate portion 24 of the substrate terminal 16, and the pair of stepped surfaces 44 and 44 form a pair of substrate abutment portions 26 and 26 that are formed on opposite sides of the conducting portion 18. Accordingly, the substrate terminal 16 can be more advantageously held upright on the printed circuit board 12, working in conjunction with the press-fitted portion 30. Moreover, the recessed portion 48 that is cut obliquely inwardly in a recessed shape in an intersection region between the substrate abutment portion 26 and the press-fitted portion 30 of the conducting portion 18 is formed on the inward side, in the width direction, of each of the substrate abutment portions 26. Accordingly, it is possible to prevent, in advance, the problem that a rounded remaining portion is formed in the intersection region between the substrate abutment portion 26 and the press-fitted portion 30 during production of the substrate terminal 16. Therefore, it is possible to advantageously prevent the occurrence of such a problem in which the substrate terminal 16 is provided upright in an inclined state on the printed circuit board 12 as a result of the aforementioned remaining portion interfering with the peripheral edge or the like of the upward opening of the through hole 14 during insertion of the substrate terminal 16 into the through hole 14. In addition, the recessed portions 48 are formed so as to be open around the press-fitted portion 30, so that any excess solder can be successfully absorbed, making it possible to advantageously contribute to reliable bonding between the printed wirings 58a, 58b, 60a, and 60b and the substrate terminal 16 using the solder 68.

Although an embodiment of the present invention has been described above in detail, the invention is not intended to be limited by the specific description thereof. For example, the substrate terminal 16 is formed by press punching a metal plate in the present embodiment, but may be formed using a metal strip that has been cut into a longitudinal flat plate shape or a metal rectangular wire that has been cut into a predetermined length, in place of a metal plate. The recessed portion 48 is formed in the substrate terminal 16 in the present embodiment, but may not be necessarily formed. In addition, although the four-layer printed wirings 58a, 58b, 60a, and 60b are provided in the present embodiment, the present invention also encompasses a configuration having only a single-layer printed wiring 58a.

What is claimed is:

1. A substrate terminal-equipped printed circuit board in which a conducting portion of a substrate terminal provided upright on a printed circuit board is inserted into a through hole of the printed circuit board so as to be electrically connected to printed wiring, wherein
the conducting portion of the substrate terminal includes: a press-fitted portion that is provided at a proximal end portion thereof and is press-fitted into the through hole; and a loosely inserted portion that is provided so as to extend from the press-fitted portion to a distal end portion thereof, has a narrower width than the press-fitted portion, and is inserted into the through hole with a gap therebetween, and
the press-fitted portion of the conducting portion is in pressure contact only with the printed wiring provided on a surface layer of the printed circuit board and with an insulating layer located immediately below the printed wiring.

2. The substrate terminal-equipped printed circuit board according to claim 1, wherein
the loosely inserted portion constitutes at least ¾ of a region where the conducting portion of the substrate terminal is disposed in the through hole of the printed circuit board, in a length direction of the through hole.

3. The substrate terminal-equipped printed circuit board according to claim 1, wherein
the press-fitted portion of the conducting portion is spaced apart from at least a lower portion of the insulating layer located immediately below the printed wiring provided on the surface layer of the printed circuit board.

4. The substrate terminal-equipped printed circuit board according to claim 1, wherein
a width dimension of an intermediate portion, in a length direction, of the substrate terminal is set to be larger than a width dimension of the conducting portion, and stepped surfaces between the conducting portion and the intermediate portion form a pair of substrate abutment portions on opposite sides of the conducting portion, and
a recessed portion that is cut inwardly in a recessed shape in an intersection region between the substrate abutment portion and the press-fitted portion of the conducting portion is formed on an inward side of each of the substrate abutment portions.

5. The substrate terminal-equipped printed circuit board according to claim 1, wherein
the loosely inserted portion of the conducting portion includes: a straight portion that is formed on a proximal end side thereof, extends with a constant width dimension, and is disposed within the through hole; and a tapered portion that is formed on a distal end side thereof, has a width gradually narrowing toward the distal end side, and protrudes outward from the through hole.

6. The substrate terminal-equipped printed circuit board according to claim 2, wherein the press-fitted portion of the conducting portion is spaced apart from at least a lower portion of the insulating layer located immediately below the printed wiring provided on the surface layer of the printed circuit board.

7. The substrate terminal-equipped printed circuit board according to claim 2, wherein a width dimension of an intermediate portion, in a length direction, of the substrate terminal is set to be larger than a width dimension of the conducting portion, and stepped surfaces between the conducting portion and the intermediate portion form a pair of substrate abutment portions on opposite sides of the conducting portion, and a recessed portion that is cut inwardly in a recessed shape in an intersection region between the substrate abutment portion and the press-fitted portion of the conducting portion is formed on an inward side of each of the substrate abutment portions.

8. The substrate terminal-equipped printed circuit board according to claim 3, wherein a width dimension of an intermediate portion, in a length direction, of the substrate terminal is set to be larger than a width dimension of the conducting portion, and stepped surfaces between the conducting portion and the intermediate portion form a pair of substrate abutment portions on opposite sides of the conducting portion, and a recessed portion that is cut inwardly in a recessed shape in an intersection region between the substrate abutment portion and the press-fitted portion of the conducting portion is formed on an inward side of each of the substrate abutment portions.

9. The substrate terminal-equipped printed circuit board according to claim 2, wherein the loosely inserted portion of the conducting portion includes: a straight portion that is formed on a proximal end side thereof, extends with a constant width dimension, and is disposed within the through hole; and a tapered portion that is formed on a distal end side thereof, has a width gradually narrowing toward the distal end side, and protrudes outward from the through hole.

10. The substrate terminal-equipped printed circuit board according to claim 3, wherein the loosely inserted portion of the conducting portion includes: a straight portion that is formed on a proximal end side thereof, extends with a constant width dimension, and is disposed within the through hole; and a tapered portion that is formed on a distal end side thereof, has a width gradually narrowing toward the distal end side, and protrudes outward from the through hole.

11. The substrate terminal-equipped printed circuit board according to claim 4, wherein the loosely inserted portion of the conducting portion includes: a straight portion that is formed on a proximal end side thereof, extends with a constant width dimension, and is disposed within the through hole; and a tapered portion that is formed on a distal end side thereof, has a width gradually narrowing toward the distal end side, and protrudes outward from the through hole.
